(19) United States
(12) Patent Application Publication
(10) Pub. No.: US 2006/0186813 A1
(43) Pub. Date: Aug. 24, 2006

(54) Plasma display panel

(76) Inventors: Tae-Woo Kim, Suwon-si (KR); Jeong-Nam Kim, Suwon-si (KR); Byoung-Min Chun, Suwon-si (KR); Jeong-Doo Yi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/301,625

(22) Filed: Dec. 13, 2005

(30) Foreign Application Priority Data
Feb. 22, 2005 (KR) 10-2005-0014434

(51) Int. Cl. H01J 17/49

(52) U.S. Cl. 313/583; 313/584; 313/582

(57) ABSTRACT

A plasma display panel may have an enhanced luminescence efficiency and a reduced discharge voltage under an opposed discharge scheme. The disclosed plasma display panel device includes a first substrate and a second substrate disposed apart from each other, the first substrate have a substantially planar surface facing away from the second substrate. The device further includes a plurality of address electrodes extending along a first direction and a plurality of partitioning walls located between the first and second substrates defining a plurality of discharge cells. The partitioning walls include a first partitioning wall and a second partitioning wall both extending generally along a second direction. The device further includes a phosphor layer formed on a surface of the plurality of discharge cells, a first electrode and a second electrode. The first electrode extends generally along the second direction and buried in the first partitioning wall, and is located at a first distance from the substantially planar surface. The second electrode extends generally along the second direction and buried in the second partitioning wall, and is located at a second distance from the substantially planar surface. The second distance is greater than the first distance.

### CROSS-REFERENCE TO RELATED APPLICATION

This application claims priority to and the benefit of Korean Patent Application No. 10-2005-0014434 filed in the Korean Intellectual Property Office on Feb. 22, 2005, the entire content of which is incorporated herein by reference.

### BACKGROUND

1. Field

The present invention relates to an information display technology. More particularly, the present invention relates to a plasma display panel (PDP).

2. Discussion of Related Technology

A three-electrode surface-discharge type of plasma display panel (PDP) is known in the art. The three-electrode surface-discharge type of PDP includes two substrates between which a discharge gas is filled. One of the two substrates includes sustain electrodes and scan electrodes, both of which extend in a first direction, and the other substrate is disposed apart from the one substrate and includes address electrodes extending in a second direction generally perpendicular to the first direction.

Whether a discharge cell of the PDP is to be discharged or not is determined by address discharge occurring between a scan electrode and an address electrode. A sustain discharge by which an image is actually displayed is achieved by the sustain electrodes and the scan electrodes formed on the same plane.

Visible light is generated in the PDP by using a glow discharge. It takes several stages for the visible light to reach human eyes from the generation of the glow discharge. In more detail, when a glow discharge is generated, excitation of a gas is caused by collisions of electrons and gas molecules, and the excited gas emits UV rays. The UV rays excite phosphor materials formed on the discharge cell, and the phosphor layer produces visible light. The visible light finally reaches human eyes after passing through a transparent substrate. A substantial loss of power occurs through the various stages of the discharge process.

The glow discharge is triggered by applying a high voltage higher than a discharge firing voltage between a sustain electrode and a scan electrode. That is, a very high voltage is required in order to trigger such a discharge. Once a discharge is triggered, voltage distribution between a cathode and an anode of a discharge cell is distorted by a space charge effect formed at a dielectric layer near the cathode and the anode.

In more detail, the space between the two electrodes may be divided into three regions, namely, a cathode sheath region near the cathode taking a majority of a voltage applied to the two electrodes for the discharge, an anode sheath region near the anode taking a part of the voltage, and a positive column region formed between the two sheath regions and negligibly taking voltage. Electron heating efficiency of the cathode sheath region depends on a secondary electron emission coefficient of a protective layer (typically, an MgO layer) formed on a surface of a dielectric layer, and the positive column region consumes most of its input power for heating electrons.

A Xenon gas (as a typical gas used as a discharge gas) is excited to an excited state by collision with ambient electrons, and vacuum ultraviolet (VUV) is generated when the excited Xenon gas returns to its stable state. Therefore, in order to increase the luminescence efficiency (i.e., a ratio of the energy used for generating the visible light to the input power), the likelihood of collisions of the electrons and the Xenon gas may need be to increased. In addition, in order to increase the likelihood of collisions of the electrons and the Xenon gas, the electron heating efficiency may need to be raised.

Most of the input power is consumed in the cathode sheath region, however, the electron heating efficiency is low in that region. In the positive column region, only a small portion of the input power is consumed and the electron heating efficiency is very high. Therefore, the luminescence efficiency may be increased by enlarging the positive column region (that is, a discharge gap).

From various values of the ratio (E/n) of the electric field (E) in the discharge gap with respect to the gas density (n) within the discharge cell, it is understood that, at a given ratio of E/n, an electron consumption ratio (i.e., a ratio of consumed electrons to total amount of electrons) increases on the order of the number of excited Xenon atoms (Xe*), Xenon ions (Xe⁺), excited Neon atoms (Ne*), and Neon ions (Ne⁺). In addition, at a given ratio of E/n, the electron energy decreases as a partial pressure of Xenon increases. In other words, a decrease of the electron energy results in an increase of the partial pressure of Xenon. When the partial pressure of Xenon is increased, the electron consumption ratio of the excited Xenon atoms (Xe*) (i.e., a ratio of electrons used for the excitation of Xenon atoms) is increased relative to the Xenon ions (Xe⁺), the excited Neon atoms (Ne*), and the Neon ions (Ne⁺), and accordingly, the luminescence efficiency may be enhanced.

As described above, an enlargement of the positive column region may result in an increase of electron heating efficiency. In addition, an increase of the partial pressure of Xenon may result in an effective heating of electrons used for the excitation of the Xenon atoms (Xe*). Therefore, the above two features may either or both be used for increasing the electron heating efficiency, and thereby enhance the luminescence efficiency.

However, both the enlargement of the positive column region and the increase of the partial pressure of Xenon require an increase of the discharge firing voltage, which usually increases the manufacturing costs of a PDP. Therefore, it is highly desirable to enlarge the positive column region or increase the partial pressure of Xenon while keeping the discharge firing voltage low.

With the same size of discharge gap and the same value of gas pressure, the discharge firing voltage may be lowered in an opposed discharge scheme, in which scan and sustain electrodes face each other with a predetermined gap compared to a surface discharge scheme.

The above information disclosed in this Background section is only for enhancement of understanding of the background of the invention, and is not an admission of prior art.

### SUMMARY OF CERTAIN INVENTIVE ASPECTS

Various embodiments of the inventive PDP may have enhanced luminescence efficiency with a reduced discharge voltage under an opposed discharge scheme.

An exemplary plasma display panel according to an embodiment of the present invention includes first and second substrates, a plurality of address electrodes arranged on the first substrate, a plurality of barrier ribs, a phosphor layer, a plurality of first electrodes, and a plurality of second electrodes. The first substrate and the second substrate are arranged apart from but facing each other. The plurality of barrier ribs partition a space between the first and second substrates into a plurality of discharge cells and include a plurality of first barrier rib members arranged in parallel with the address electrodes and a plurality of second barrier rib members formed in a direction crossing the address electrodes. The phosphor layer is formed in the plurality of discharge cells. The plurality of first electrodes and the plurality of second electrodes are formed within the second barrier rib members, and they are alternately arranged with respect to a longitudinal direction of the address electrodes. The plurality of first electrodes and the plurality of second electrodes are formed at different positions in a direction perpendicular to the first substrate.

In a further embodiment, one plurality of electrodes among the plurality of first electrodes and the plurality of second electrodes are positioned close to the first substrate, and another plurality of electrodes thereamong are positioned close to the second substrate. In a further embodiment, one plurality of electrodes participating in an address discharge among the plurality of first electrodes and the plurality of second electrodes are positioned close to the address electrodes.

In a further embodiment, on the first substrate, a plurality of projections projecting toward the second substrate are formed between address electrodes. In a further embodiment, a plurality of projections corresponding to the first barrier rib members and the second barrier rib members are formed on the second substrate at its interior side facing the first substrate.

In a further embodiment, the second barrier rib members are formed of a dielectric material. In a further embodiment, a protective layer that is opaque with respect to visible light is formed exterior to the second barrier rib members. In a further embodiment, a plurality of middle electrodes are formed on the second substrate in a direction crossing the plurality of address electrodes.

### BRIEF DESCRIPTION OF THE DRAWINGS

FIG. 1 is an exploded perspective view of a portion of a PDP according to a first exemplary embodiment of the present invention.

FIG. 2 is a cross-sectional view of a portion of a PDP according to a first exemplary embodiment of the present invention.

FIG. 3 is a top plan view of a portion of a PDP according to a first exemplary embodiment of the present invention illustrating a configuration of electrodes and discharge cells thereof.

FIG. 4 illustrates a positional relationship between first and second electrodes in a PDP according to a first exemplary embodiment of the present invention.

FIG. 5 is an exploded perspective view of a portion of a PDP according to a second exemplary embodiment of the present invention.

FIG. 6 is a cross-sectional view of a portion of a PDP according to a second exemplary embodiment of the present invention.

### DETAILED DESCRIPTION OF EMBODIMENTS

Exemplary embodiments of the present invention will hereinafter be described in detail with reference to the accompanying drawings.

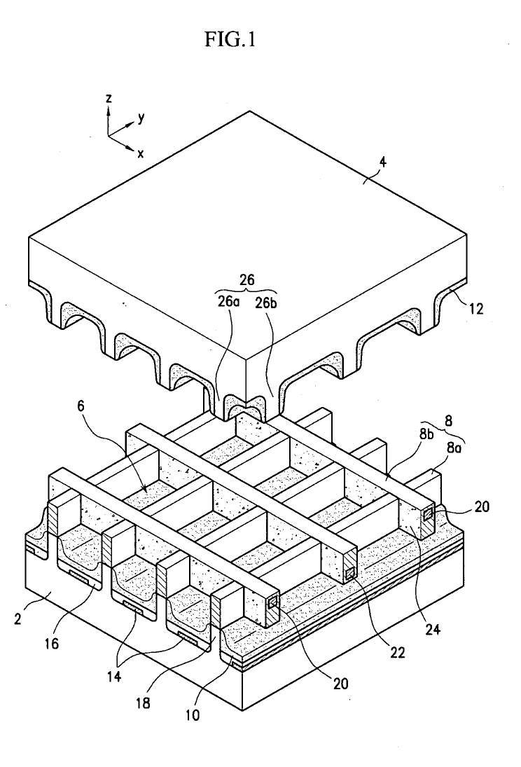

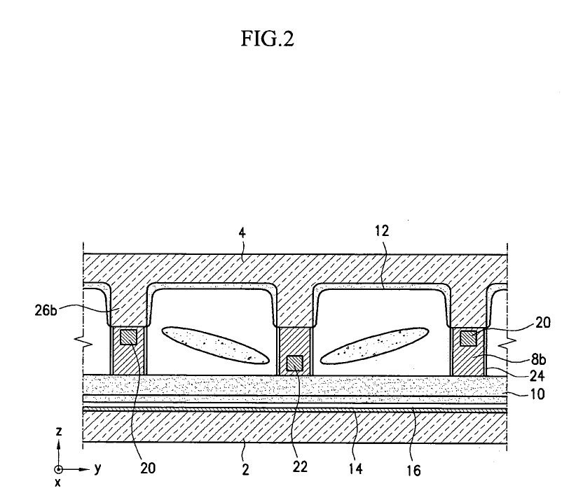

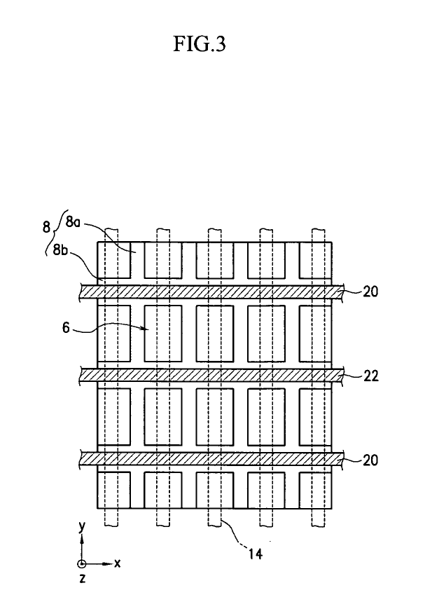

FIG. 1 is an exploded perspective view of a portion of a PDP according to a first exemplary embodiment of the present invention. FIG. 2 is a cross-sectional view of a portion of a PDP according to a first exemplary embodiment of the present invention. FIG. 3 is a top plan view of a portion of a PDP according to a first exemplary embodiment of the present invention illustrating a configuration of electrodes and discharge cells thereof.

Referring to the drawings, in a PDP according to an embodiment of the present invention, a first substrate (hereinafter called a rear substrate) 2 and a second substrate (hereinafter called a front substrate) 4 are disposed to face each other with a predetermined distance therebetween, and a space between the rear substrate 2 and the front substrate 4 is partitioned into a plurality of discharge cells 6 by barrier ribs 8.

In each discharge cell 6, phosphor layers 10 and 12 that absorb UV rays and instead emits visible light are respectively formed on the rear substrate 2 and the front substrate 4. In addition, a discharge gas (e.g., a mixture gas including Xenon (Xe), Neon (Ne), etc.) is filled in the discharge cell 6 for generating a plasma discharge.

On an interior side of the rear substrate 2 facing the front substrate 4, address electrodes 14 are formed in a direction (y-axis direction in the drawing), and a dielectric layer 16 is formed to cover the address electrodes 14. Adjacent address electrodes 14 are apart from each other by a distance corresponding to a size of the discharge cells 6.

In addition, on the rear substrate 2, rear substrate projections 18 projecting toward the front substrate 4 are formed between adjacent address electrodes 14. The rear substrate projections 18 are formed in parallel with the address electrodes 14, i.e., along a longitudinal direction of the address electrodes 14. In addition, the rear substrate projections 18 also take part in partitioning the space between the two substrates 2 and 4 into discharge cells 6, in cooperation with the barrier ribs 8.

The phosphor layer 10 is formed on a top of the dielectric layer 16 and on lateral sides of the rear substrate projections 18. The rear substrate projections 18 contribute to enlarging an area of the phosphor layer 10. As a result, an area emitting visible light during the sustain discharge is increased, and the luminescence efficiency can be enhanced.

The rear substrate projections 18 may be integrally formed with the rear substrate 2. That is, such rear substrate projections 18 may be formed, for example, by machining a blank for the rear substrate to have such rear substrate projections 18, or by etching a blank to form concave portions or recesses thereon.

The barrier ribs 8 include first barrier rib members 8a disposed between adjacent address electrodes 14 and in parallel therewith and second barrier rib members 8b crossing the first barrier rib members 8a, such that separated discharge spaces are formed by the barrier rib members 8a and 8b. Each first barrier rib member 8a is formed on each rear substrate projections 18.

A first electrode 20 or a second electrode 22 is extendedly formed in an interior of each of the second barrier rib members 8b. For example, the first electrodes 20 may respectively be formed in odd numbered second barrier rib members 8b, and the second electrodes 22 may respectively be formed in even numbered second barrier rib members 8b. In other words, according to an exemplary embodiment of the present invention, the first electrodes 20 and the second electrodes 22 are alternately arranged with respect to the longitudinal direction of the address electrodes 14 (refer to FIG. 3).

The second electrodes 22 generate an address discharge in cooperation with the address electrodes 14 during the address period to select turn-on discharge cells among the plurality of discharge cells 6. The first electrodes 20 generate a sustain discharge in cooperation with the second electrodes 22 to sustain the discharge within the selected discharge cells during the sustain period. According to the illustrated embodiment, when viewed from the top or bottom in FIG. 1 like FIG. 3, each second electrode 22 is disposed between two adjacent first electrodes 20. That is, each second electrode 22 is commonly used for each pair of discharge cells adjacent thereto along the longitudinal direction of the address electrode 14. Therefore, in this embodiment, the two discharge cells 6 sharing one second electrode 22 are alternately discharged. However, since the functions of the electrodes may be changed by changing signal voltages, it should not be understood that the scope of the present invention is limited to the above-described details.

Referring to FIG. 2, the first and second electrodes 20 and 22 are buried in the second barrier rib members 8b. Accordingly, during the sustain period, the sustain discharge occurs between electrodes disposed at opposite sides of the discharge cell 6. That is, the first electrode 20 and the second electrode 22 are oppositely disposed interposing the discharge cell 6, and accordingly an opposed discharge is obtained as the sustain discharge. Therefore, when compared to a surface discharge scheme in which two electrodes used for the sustain discharge are arranged on the same plane, an opposed discharge is easily and naturally achieved by the first and second electrodes 20 and 22, thereby enhancing the luminescence efficiency.

The second barrier rib members 8b are formed of a dielectric material. That is, a dielectric layer is formed on exteriors of the first electrodes 20 and the second electrodes 22. Accordingly, the second barrier rib members 8b that define discharge cells 6 may also protect the first and second electrodes 20 and 22. In addition, charges may be accumulated on the second barrier rib members 8b.

The first and second electrodes 20 and 22 may be formed by a thin film ceramic sheet (TFCS) method. In the TFCS method, an electrode unit including the first and second electrodes 20 and 22 is separately fabricated and coated with a ceramic. Then, the electrode unit is placed on the rear substrate 2.

In addition, a protective layer 24 may be formed on exteriors of the second barrier rib members 8b that bury the first and second electrodes 20 and 22. The protective layer 24 may be formed of MgO or other materials, and is formed on the entire area exposed to the plasma discharge or at least part thereof in the discharge cell 6. According to an exemplary embodiment, the first and second electrodes 20 and 22 are not formed at the front substrate 4 (that is, they do not intercept the light emitting from the discharge cell 6), and therefore, an opaque MgO (that is, MgO that is opaque with respect to visible light) may be used for the protective layer 24.

The opaque MgO shows a much higher secondary electron emission coefficient than a transparent MgO (that is, an MgO that is transparent with respect to visible light), and therefore it may help further reduce the discharge firing voltage.

Although not limited thereto, the first and second electrodes 20 and 22 may be formed of one or more metals or an alloy with high electrical conductivity.

An interior surface of the front substrate 4 facing the rear substrate 2 have areas covered with the phosphor layer 12. In addition, front substrate projections 26 are formed on the front substrate 4. The front substrate projections 26 respectively include first projections 26a respectively corresponding to the first barrier rib members 8a and second projections 26b corresponding to the second barrier rib members 8b. Concave portions or recesses defined by the front substrate projections 26 correspond to discharge cells 6. The phosphor layer 12 is formed on the surfaces of the recesses including sides of the front substrate projections 26.

The front substrate projections 26 contribute to enlarging an area of the phosphor layer 12, thereby enhancing the luminescence efficiency. The front substrate projections 26 may be integrally formed with the front substrate 4 in the same or different ways as the rear substrate projections 18 are integrally formed with the rear substrate 2.

The phosphor layer 12 formed on the front substrate 4 is also used to produce visible light upon the VUV incident thereon by the discharge in the discharge cell 6. Therefore, such a phosphor layer 12 is preferably transparent or at least partially transparent with respect to visible light. In one embodiment, the phosphor layer 12 of the front substrate 4 is formed so thin as for at least part of the visible light to pass through. In some embodiments, the phosphor layer 12 is formed on the front substrate 4 thinner than the phosphor layer 10 of the rear substrate 2.

According to such a scheme, the VUV may be maximally utilized and the luminescence efficiency may be further enhanced.

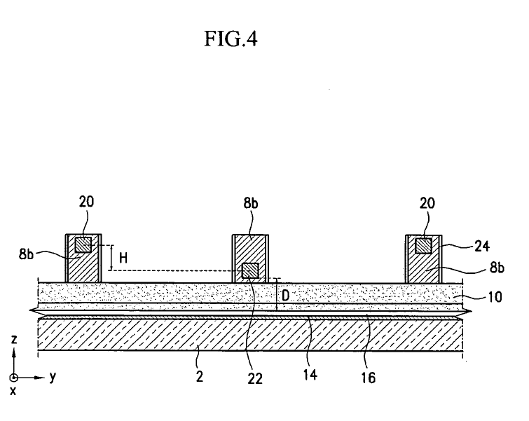

Referring to FIG. 2 and FIG. 4, according to an exemplary embodiment, the first and second electrodes 20 and 22 are formed at different heights from the rear substrate 2 (i.e., at different positions in a direction perpendicular to the rear substrate 2). More particularly, in the illustrated embodiment, the second electrodes 22 participating in the address discharge are positioned closer to the rear substrate 4 than the first electrodes 20. That is, the positions of the first electrodes 20 are biased to tops of the second barrier rib members 8b, and the positions of the second electrodes 22 are biased to bottoms of the second barrier rib members 8b.

FIG. 4 shows a height difference H between the centers of the first and second electrodes 20 and 22. Such a height difference of the first and second electrodes 20 and 22 from the rear substrate 4 lengthens a discharge path of the opposed discharge in the sustain discharge. Referring back to FIG. 2, the tilted ovals drawn in each discharge cell schematically illustrates the discharge path during the sustain discharge in this embodiment. Consequently, more UV rays can contribute to emission of visible light, and therefore the discharge efficiency may be enhanced, even though the area of the phosphor layers 10 and 12 remains the same. It is notable that the lengthening of the discharge path implies an enlargement of the discharge area and more utilization of the positive column region in the negative glow region.

According to the illustrated embodiment, the first and second electrodes 20 and 22 are formed with a height difference H, thereby lengthening the discharge path. Therefore, the positive column region is increased during the sustain discharge and accordingly the discharge efficiency is enhanced.

In addition, the rear substrate 4 is closer to the second electrode 22 than to the first electrode 20, and thus the address electrode 14 is closer to the second electrode 22 than to the first electrode 20. Therefore, an address voltage applied between the second electrodes 22 and the address electrodes 14 may be lowered since the required discharge firing voltage is generally proportional to a distance between the address electrode 14 and the second electrode 22, as is known in the art. The distance between the address electrode 14 and the second electrode 22 is shown in FIG. 4 as a height difference D between a top of the address electrode 14 and a bottom of the second electrode 22.

As described above, according to embodiments of the present invention, an opposed discharge may be obtained as the sustain discharge, and thus the discharge firing voltage may be lowered. In addition, the discharge path of the opposed discharge may be lengthened by the height difference of the first and second electrodes, thereby enhancing the discharge efficiency. Furthermore, since the second electrode is positioned close to the address electrode, the address discharge may be more easily triggered.

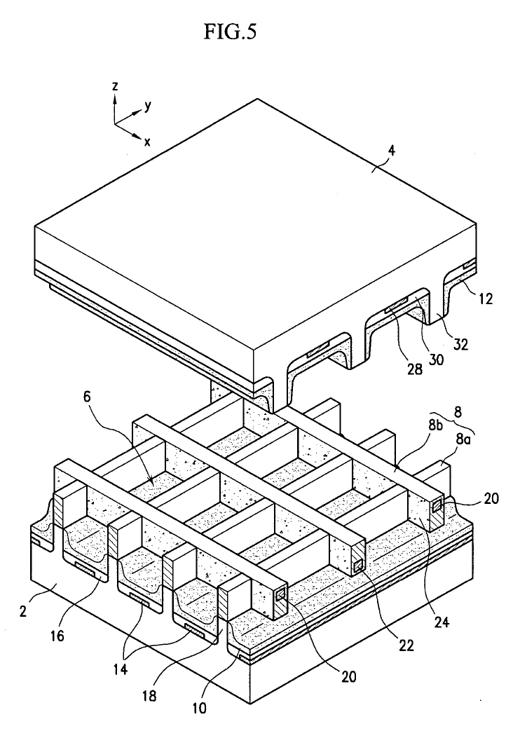

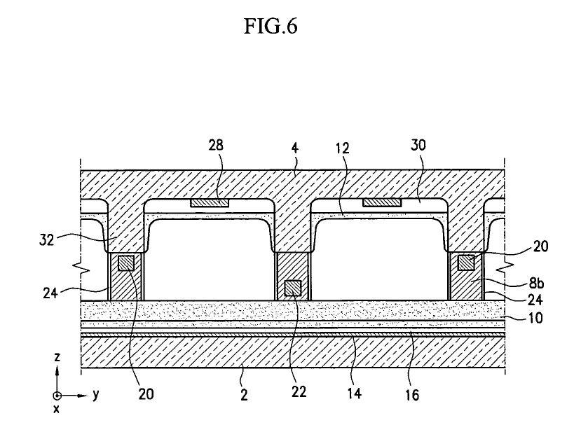

FIG. 5 is an exploded perspective view of a portion of a PDP according to a second exemplary embodiment of the present invention, and FIG. 6 is a cross-sectional view of a portion of a PDP according to a second exemplary embodiment of the present invention.

Referring to the drawings, a PDP according to the present exemplary embodiment is similar to one according to the first exemplary embodiment, but it further includes middle electrodes 28 at the front substrate 4.

The middle electrodes 28 are extended along a direction crossing the address electrodes 14. In addition, adjacent middle electrodes 28 are apart from each other by a distance corresponding to a size of the discharge cells 6. The middle electrodes 28 are respectively arranged in correspondence with respective lines of discharge cells 6 defined by the barrier ribs 8, and they are covered with a dielectric layer 30 formed on the front substrate 4.

In addition, on the front substrate 4, front substrate projections 32 projecting toward the rear substrate 2 are formed between adjacent middle electrodes 28. The front substrate projections 32 are formed in parallel with the middle electrodes 28, i.e., along a longitudinal direction of the middle electrode 28. In addition, the front substrate projections 32 also take part in partitioning the space between the two substrates 2 and 4 into discharge cells 6, in cooperation with the barrier ribs 8. The middle electrodes 28 and the dielectric layer 30 are formed between adjacent front substrate projections 32, and the phosphor layer 12 is formed on a lower side of the dielectric layer 30 and lateral sides of the front substrate projections 32.

The middle electrodes 28 generate the address discharge in cooperation with the address electrodes 14 during the address period so as to select turn-on discharge cells. The first electrodes 20 generate the sustain discharge in cooperation with the second electrodes 22 during the sustain period to maintain the discharge within the selected discharge cells. In this embodiment, the address electrode 14 and the middle electrode 28 are oppositely disposed interposing the discharge cell 6, and accordingly an opposed discharge is obtained as the address discharge. However, since the functions of the electrodes may be changed by changing signal voltages, it should not be understood that the scope of the present invention is limited to the above-described details.

Therefore, according to a PDP according to the present exemplary embodiment, the address discharge may be triggered more easily between the address electrode 14 and the middle electrode 28, and thus the discharge firing voltage may be lowered. Furthermore, the height difference between the first and second electrodes 20 and 22 lengthens the discharge path of the sustain discharge, and thus the discharge efficiency may be enhanced. In other embodiments, configurations and relations of the first electrodes 20 and the second electrodes 22 may differ from the illustrations while the others remain the same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display panel device, comprising:
a first substrate and a second substrate disposed apart from each other, the first substrate having a substantially planar surface facing away from the second substrate;
an address electrode extending generally along a first direction;
a plurality of partitioning walls located between the first and second substrates and defining a plurality of discharge cells, the plurality of partitioning walls comprising a first partitioning wall extending generally along a second direction and a second partitioning wall extending generally in the second direction;
a phosphor layer formed on a surface of the plurality of discharge cells;
a first electrode extending generally along the second direction and buried in the first partitioning wall, the first electrode being located at a first distance from the substantially planar surface;
a second electrode extending generally along the second direction and buried in the second partitioning wall, the second electrode being located at a second distance from the substantially planar surface; and
wherein the second distance is greater than the first distance.

2. The plasma display panel device of claim 1, wherein the first distance is the longest distance between the first electrode and the substantially planar surface, and wherein the second distance is the longest distance between the second electrode and the substantially planar surface.

3. The plasma display panel device of claim 1, wherein the address electrode has a distance from the substantially planar surface that is greater than the second distance.

4. The plasma display panel device of claim 1, wherein the device is configured to apply an address discharge voltage between the second electrode and the address electrode during an address discharge period.

5. The plasma display panel device of claim 1, wherein the device is configured to apply a sustain discharge voltage between the first electrode and the second electrode during a sustain discharge period.

6. The plasma display panel device of claim 1, wherein the plurality of partitioning walls comprises a plurality of portions integrally formed with at least one of the first and second substrates.

7. The plasma display panel device of claim 6, wherein the plurality of integrally formed portions comprises projections on the first substrate extending toward the second substrate and generally along the first direction.

8. The plasma display panel device of claim 7, wherein the address electrode is located between two neighboring projections and covered with a dielectric layer, and wherein the phosphor layer is formed over the dielectric layer.

9. The plasma display panel device of claim 6, wherein the plurality of integrally formed portions comprises projections on the second substrate extending toward the first substrate, wherein the projections are configured to form a mesh configuration.

10. The plasma display panel device of claim 1, wherein the first partitioning wall comprises a portion made of a material different from a material of the first or second substrate, and wherein the first electrode is buried within the portion of the first partitioning wall.

11. The plasma display panel device of claim 1, wherein the plurality of partitioning walls are made of at least one substantially non-conductive material.

12. The plasma display panel device of claim 1, further comprising a protective layer formed over a surface of at least one of the first and second partitioning walls.

13. The plasma display panel device of claim 1, further comprising a third electrode extending generally along the second direction and having a third distance from the substantially planar surface, the third distance being smaller than the first distance, wherein the device is configured to apply an address voltage between the address electrode and the third electrode during an address discharge period.

14. A plasma display device, comprising
an address electrode extending generally along a first direction;
a first electrode extending generally along a second direction, which crosses the first direction, the first electrode having a first distance, which is the shortest distance between the first electrode and the address electrode;
a second electrode extending generally along the second direction, the second electrode having a second distance, which is the shortest distance between the second electrode and the address electrode, the first distance being greater than the second distance; and
wherein the device is configured to apply a sustain discharge voltage between the first and second electrodes to create a sustain plasma discharge.

15. The device of claim 14, wherein the device is configured to apply an address discharge voltage between the second electrode and the address electrode.

16. The device of claim 15, wherein the address discharge voltage is less than the sustain discharge voltage.

17. The device of claim 15, further comprising a third electrode extending generally along the second direction, wherein the device is configured to apply an address discharge voltage between the third electrode and the address electrode.

18. The device of claim 15, further comprising a plurality of partitioning walls forming a matrix of discharge cells, wherein one of the first and second electrodes is buried in one of the plurality of partitioning wall.

19. The device of claim 18, wherein the plurality of partitioning walls comprises a first partitioning wall and a second partitioning wall, each of which extends generally along the second direction, wherein the first electrode is buried in the first partitioning wall, and the second electrode is buried in the second partitioning wall.

20. A plasma display device, comprising:
a first substrate comprising a substantially planar surface and a plurality of first projections extending away from the substantially planar surface;
a second substrate comprising a plurality of second projections extending toward the first substrate;
a plurality of ribs located between the first and second substrates, the plurality of ribs interconnecting the plurality of the first projections and the second projections such that a plurality of enclosed cells are defined by the first substrate, the second substrate and the plurality of ribs, wherein at least one of the enclosed cells has a first interior wall facing the first substrate, a second interior wall facing the second substrate and a plurality of side interior walls; and
a phosphor layer formed on both of the first and second interior walls, wherein the phosphor layer formed on at least one of the first and second walls is substantially transparent with respect to visible light.

21. The device of claim 20, wherein the phosphor layer formed on the first interior wall is thinner than the phosphor layer formed on the second interior wall.

22. The device of claim 20, wherein the phosphor layer formed on the first interior wall is substantially transparent with respect to visible light, and the phosphor layer formed on the second interior wall is not transparent with respect to visible light.

23. The device of claim 20, wherein the phosphor layer formed on the first interior wall is more transparent than the phosphor layer formed on the second interior wall with respect to visible light.
